(19) United States
(12) Patent Application Publication
(10) Pub. No.: US 2009/0242234 A1
(43) Pub. Date: Oct. 1, 2009

(54) FASTENER FOR SIDE-WALL OF ELECTRICAL DEVICE

(75) Inventor: WEN-YAN YANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/411,344

(22) Filed: Mar. 25, 2009

(30) Foreign Application Priority Data
Mar. 27, 2008 (CN) 200810300737.X

(51) Int. Cl. H01B 7/00

(52) U.S. Cl. 174/135

(57) ABSTRACT

A fastener is for fastening wires in an electrical device. The fastener includes a base board and a catch. The base board is connected to the electrical device. The catch extends upwards from the base board. The catch includes a supporting portion extending upwards from the base board, a main portion extending from the supporting portion and above the base board, and a restricting portion extending downwards from the main portion. A vertical distance between the restricting portion and the base board is smaller than a vertical distance between the main portion and the base board. A side-wall of an electrical device using the fastener is also provided.

### BACKGROUND

1. Technical Field

The present disclosure relates to fasteners, and particularly, to a fastener for fastening wires in an electrical device.

2. Description of Related Art

Electrical wiring is widely used for carrying signals between components in electrical devices, such as computers, televisions, etc. To prevent short-circuits, to have a neat appearance, and/or to avoid clutter, the wiring are often secured to side-walls or other flat surface that they traverse over or next to by sticky tapes. However, because of heat, dust, or useful life or a combination, the adhesive of the sticky tapes tends to lose it strength and the sticky tapes may unravel. Thus, the problems as noted above may still occur. Also, the unraveled tapes may be an inconvenient when repairing or cleaning the electrical devices.

Therefore, a fastener and an electrical device using the same are needed in the industry to address the aforementioned deficiency.

### BRIEF DESCRIPTION OF THE DRAWINGS

FIG. 1 is a schematic diagram showing a side-wall of an electrical device in accordance with an exemplary embodiment.

FIG. 2 is a schematic diagram showing two wires fixed to the side-wall of an electrical device.

FIG. 3 is a partial enlarged view of the circled portion III of FIG. 2 showing a fastener.

FIG. 4 is a cross-sectional view taken along line IV-IV of the fastener.

### DETAILED DESCRIPTION

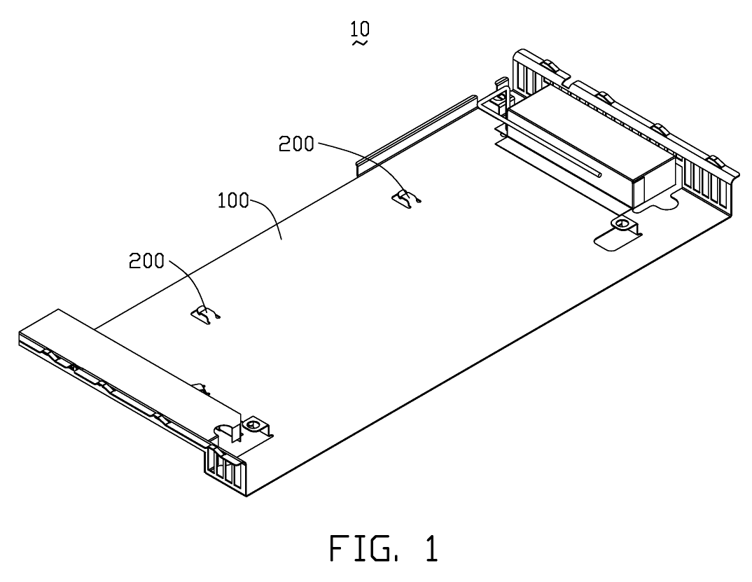

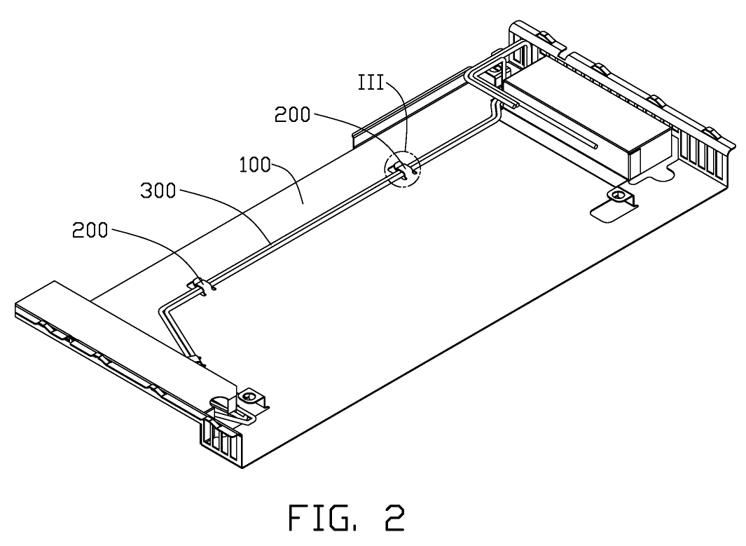

Referring to FIGS. 1 and 2, a side-wall 10 in accordance with an exemplary embodiment is used in an electrical device (not shown), such as a computer. The side-wall 10 includes a rectangular main sheet 100. Two wires 300 are disposed on the main sheet 100. Moreover, the main sheet 100 also forms two fasteners 200 for attaching the wires 300 to the main sheet 100.

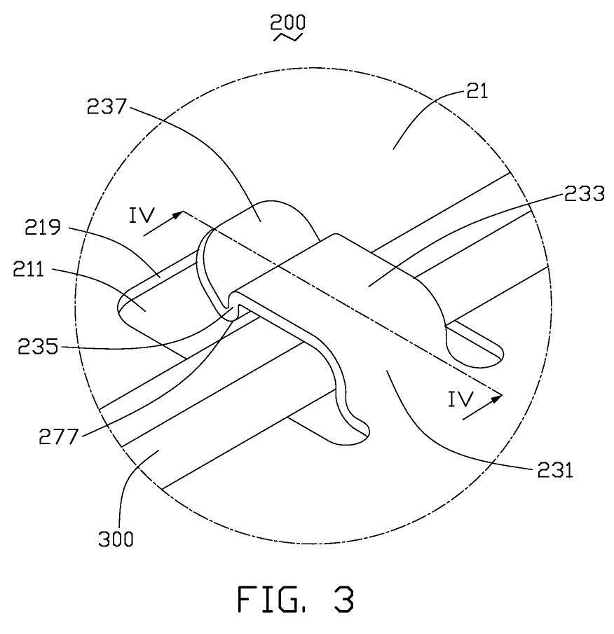

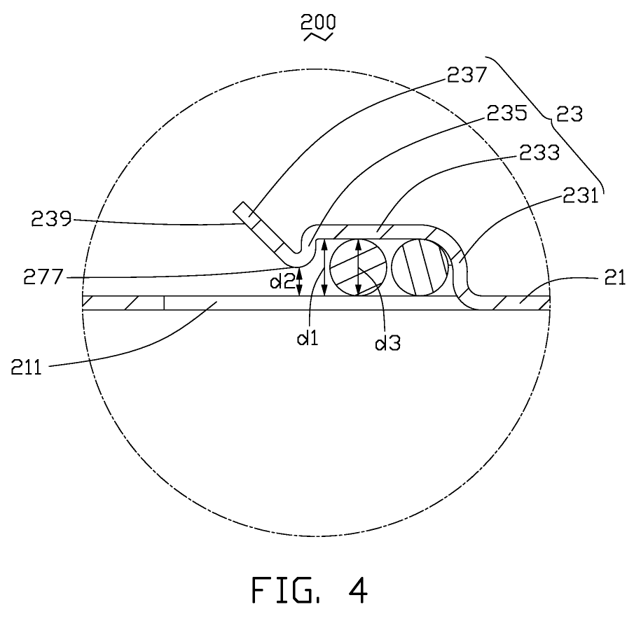

Also referring to FIGS. 3 and 4, each fastener 200 includes a base board 21 and a catch 23 extending upwards from the base board 21. The base board 21 includes an inner edge 219 defining a rectangular slot 211 therein. In the embodiment, the base board 21 is a part of the main sheet 100. In another embodiment, the base board 21 may be separated from the main sheet 100 and attached to the main sheet 100 with screws.

The catch 23 extends above the rectangular slot 211. The catch 23 is composed of a supporting portion 231, a main portion 233, a restricting portion 235, and a guiding portion 237. The supporting portion 231 extends upwards from the inner edge 219 and is bended at right angles to form the main portion 233. The main portion 233 is substantially parallel to the base board 21. A first vertical distance d1 between the main portion 233 and the base board 21 is larger than or equal to a diameter d3 of the wire 300.

The restricting portion 235 extends downwards from the main portion 233 to a connection position 277 above the rectangular slot 211. A second vertical distance d2 between the connection position 277 and the base board 21 is smaller than the diameter d3, so as to block the wires 300 from disengaging from the fastener 200. The guiding portion 237 is attached to an outside of the catch 23 and extends at an angle to form an inclined surface 239 facing the rectangular slot 211.

In assembly, the wires 300 will slide along the inclined surface 239 to the connection position 277 of the restricting portion 235 and the guiding portion 237. An extra force is exerted on the wires 300 to push the connection position 277 of the restricting portion 235 and the guiding portion 237 away from the base board 21, to drive the wires 300 to be fixed in the fastener 200. The restricting portion 235 and the guiding portion 237 return to their original positions to restrict the wires 300.

In other embodiments, the supporting portion 231 may be an incline with respect to the base board 21, and the main portion 233 may be oblique to the base board 21. The supporting portion 231, the main portion 233, and the restricting portion 235 combine to form an arc above the rectangular slot 211. The side-wall 10 may be a shielding apparatus for shielding electronic chips from electromagnetic interference (EMI).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fastener for fastening wires in an electrical device, the fastener comprising:
a base board connected to the electrical device; and
a catch extending upwards from the base board, the catch comprising:
a supporting portion extending upwards from the base board;
a main portion extending from the supporting portion and above the base board; and
a restricting portion extending downwards from the main portion;
wherein a vertical distance between the restricting portion and the base board is smaller than a vertical distance between the main portion and the base board.

2. The fastener according to claim 1, further comprising a guiding portion attached to an outside of the catch.

3. The fastener according to claim 2, wherein the guiding portion extends obliquely from the restricting portion.

4. The fastener according to claim 1, wherein the base board comprises an inner edge defining a slot therein.

5. The fastener according to claim 4, wherein the supporting portion extends upwards from the inner edge and is bended at right angles to form the main portion.

6. The fastener according to claim 5, wherein the main portion is above the slot.

7. The fastener according to claim 1, wherein the base board is formed integrally with the electrical device.

8. A side-wall of an electrical device, the side-wall comprising:
a main sheet;
a wire disposed on the main sheet; and
a fastener for attaching the wire to the main sheet, the fastener comprising:
a base board connected to the electrical device; and
a catch extending upwards from the base board, the catch comprising:
a supporting portion extending upwards from the base board;
a main portion extending from the supporting portion and above the base board; and
a restricting portion extending downwards from the main portion;
wherein the wire is surrounded by the supporting portion, the main portion, and the restricting portion, and a vertical distance between the restricting portion and the base board is smaller than a diameter of the wire.

9. The side-wall according to claim 8, wherein a vertical distance between the main portion and the base board is longer than or equal to the diameter of the wire.

10. The side-wall according to claim 8, further comprising a guiding portion attached to an outside of the catch.

11. The side-wall according to claim 10, wherein the guiding portion extends obliquely from the restricting portion.

12. The side-wall according to claim 8, wherein the base board comprises an inner edge defining a slot therein.

13. The side-wall according to claim 12, wherein the supporting portion extends upwards from the inner edge and is bended at right angles to form the main portion.

14. The side-wall according to claim 13, wherein the main portion is above the slot.

15. The side-wall according to claim 8, wherein the base board is formed integrally with the electrical device.
